(19) United States
(12) Patent Application Publication
(10) Pub. No.: US 2011/0225809 A1
(43) Pub. Date: Sep. 22, 2011

(54) APPARATUS FOR REMOVABLY ATTACHING AN ITEM TO A SURFACE

(76) Inventor: Alan Francis Daher, Salisbury, NC (US)

(21) Appl. No.: 12/725,495

(22) Filed: Mar. 17, 2010

(51) Int. Cl. B23P 17/04

(52) U.S. Cl. 29/700

(57) ABSTRACT

The present invention generally includes an apparatus for removable attaching an item to a surface, including a first removable attaching means affixed on the item, and a second removable attaching means affixed to the surface: wherein, the first and the second removable attaching means are able to removable attach to each other.

### BACKGROUND OF THE INVENTION

The present invention generally relates to apparatuses for attaching and more specifically to an apparatus for removable attaching an item to a surface

Lighters and other small items such as lipstick cases, cosmetic mirrors, media players, or any type of small cases that are use a lot, tend to fall to the bottom of purses, pockets, or bags.

As can be seen, there is a need is a system that does away with digging or wondering where the small items may be located.

### SUMMARY OF THE INVENTION

In one aspect of the present invention, an apparatus for removable attaching an item to a surface is provided comprising a first removable attaching means affixed on the item and a second removable attaching means affixed to the surface: wherein, the first and the second removable attaching means are able to removable attach to each other.

These and other features, aspects and advantages of the present invention will become better understood with reference to the following drawings, description and claims.

### BRIEF DESCRIPTION OF THE DRAWINGS

FIG. 1 shows a prospective side view of an exemplary embodiment of the present invention showing a lighter wrapped in Velcro® all the way around the lighter from top to bottom.

FIG. 2 shows a back elevation view of FIG. 1

FIG. 3 shows a front elevation view of FIG. 1:

FIG. 4 shows a top elevation view of FIG. 1

FIG. 5 shows a bottom elevation view of FIG. 1. and

FIG. 6 shows a front side of an exemplary embodiment of the present invention showing a Velcro® patch.

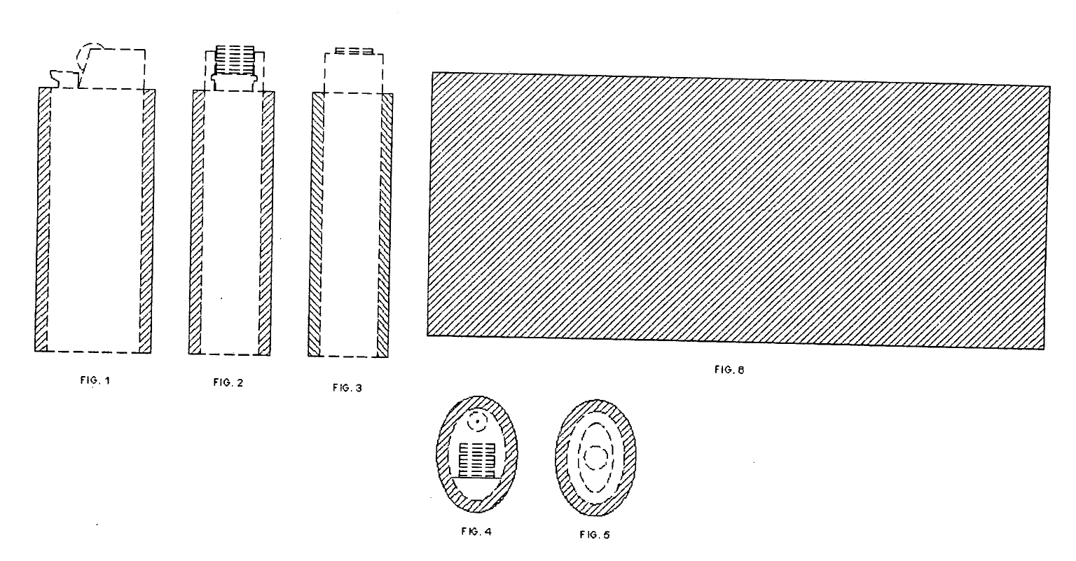

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims

Various inventive features are described below that can each be used independently of one another or in combination with other features However, any single inventive feature may not address any of the problems discussed above or may only address one of the problems discussed above. Further, one or more of the problems discussed above may not be fully addressed by any of the features described below.

Broadly, an embodiment of the present invention generally includes an apparatus for removable attaching an item to a surface including a first removable attaching means affixed on the item, and a second removable attaching means affixed to the surface: wherein the first and the second removable attaching means are able to removable attach to each other

The present invention may be made and used according to an exemplary embodiment as follows.

The present invention relates to a removable attaching means affixed to small items, such as a lighter that is able to be removable attach to another removable attaching means affixed to a surface. The removable attaching means may be any suitable removable attaching means, for example hook and loop fasteners such as Velcro®, adhesive surfaces such as double adhesive tapes snap buttons, or any other suitable removable attaching means.

The first and second removable attaching means may be in any suitable size and shape fit for the purpose, for example a patch may be provided to be approximately about 1 to about 2 inches wide by approximately about 2 to about 3 inches long

The present invention may be used, for example, by taking a lighter and affixing Velcro® on it. A patch of Velcro® may be affixed to a desirable surface for attaching the lighter thereon.

For example, a user may glue a hook and loop patch on a lighter and make a hook and loop patch which the lighter would stick too. The user may glue the hook side to the lighter or may glue the loop side to the lighter

To use this invention the user, for example can take the patch peel the back off, and stick in their favorite place like a pocket book purse car boat, belt, or anywhere they want for convenience. Then stick the lighter to it and. their lighter is there whenever they need it.

The present invention can be used on lipstick cases, cosmetic mirrors, media players, or any type of small cases that are used a lot.

It should be understood, of course, that the foregoing relates to exemplary embodiments of the invention and that modifications may be made without departing from the spirit and scope of the invention as set forth in the following claims.

What is claimed is:

1. An apparatus for removable attaching an item to a surface, comprising
a first removable attaching means affixed on the item and
a second removable attaching means affixed to the surface
wherein, the first and the second removable attaching means are able to removable attach to each other.
